(19) United States
(12) Patent Application Publication
(10) Pub. No.: US 2013/0058618 A1
(43) Pub. Date: Mar. 7, 2013

(54) IMAGING DEVICE AND IMAGING METHOD

(71) Applicants: SHUICHI AKAZAWA, KANAGAWA (JP); NOBUO OHISHI, SHIZUOKA (JP)

(72) Inventors: SHUICHI AKAZAWA, KANAGAWA (JP); NOBUO OHISHI, SHIZUOKA (JP)

(21) Appl. No.: 13/597,082

(22) Filed: Aug. 28, 2012

(30) Foreign Application Priority Data
Sep. 6, 2011 (JP) 2011-193829

(51) Int. Cl. H04N 5/91

(52) U.S. Cl. 386/210; 386/E05.003

(57) ABSTRACT

There is provided an imaging device including an imaging unit that performs photoelectric conversion with respect to object light and generates a video signal, a timing generating unit that instructs the imaging unit to generate the video signal at a predetermined imaging frame rate, a time code generating unit that generates a time code to be added to the video signal, and an output signal control unit that stores the video signal and the time code added to the video signal in a memory, reads a combination of the video signal and the time code stored in the memory at a second frame rate according to a transmission frame rate for when the video signal is transmitted to an external device, and outputs the combination.

### BACKGROUND

The present disclosure relates to an imaging device and an imaging method that are suitable for a video camera recorder performing imaging at an imaging frame rate different from a transmission frame rate of a video signal with respect to an external device.

In the related art, a method of changing an imaging frame rate of an imaging device to a desired frame rate and performing imaging has been executed to obtain a special video effect when a film is produced or a television broadcasting program is produced. If imaging and recording are performed with an imaging frame rate set to be higher than a reproduction frame rate and reproduction is performed at a normal rate, a reproduction image becomes a slow reproduction image. If imaging is performed with an imaging frame rate set to be lower than the reproduction frame rate and the reproduction is performed at the normal rate, a reproduction image becomes a fast reproduction image. Such imaging is called “variable frame rate imaging.”

As the imaging that is performed by changing the imaging frame rate, in addition to the “variable frame rate imaging,” “interval REC (intermittent recording)” for setting the number of frames recorded at one time and an interval time and automatically recording object video or “frame imaging” for performing recording only when a REC button is pressed is known.

In the imaging device such as a video camera recorder, a time code is added to an imaged video signal. Because the time code steps in units of frames, it is necessary to synchronize a carry frame number thereof at the frame rate. For this reason, instead of the time code synchronized with the imaging frame rate, the time code synchronized with the reproduction frame rate is added to the video signal imaged at the variable frame rate.

For example, Japanese Patent Application Publication No. 2005-39713 discloses a method of recording a plurality of kinds of time codes corresponding to a plurality of kinds of frame rates when recording is performed and selecting an appropriate time code from the plurality of kinds of recorded time codes when reproduction is performed.

### SUMMARY

In actual film production and the television broadcasting program production, a method of performing imaging by an imaging device, transmitting a video signal obtained by the imaging to an external device such as a recording device, and recording the video signal is executed. In this case, the video signal that is imaged by the imaging device is transmitted to the external device at a transmission frame rate determined according to a transmission standard. That is, when a video signal obtained by variable frame rate imaging is transmitted to the external device, it is necessary to convert the frame rate into the transmission frame rate determined according to the standard. In order to transmit the video signal to the external device at the imaging frame rate, it is necessary to design a new transmission standard for performing transmission at the imaging frame rate to be used exclusively for the imaging device performing the variable frame rate imaging. However, this is not realistic.

FIG. 7 shows an example of the case in which imaging and recording are performed at a frame rate of 40 P in an imaging device and a video signal obtained by the imaging is transmitted to an external device at a transmission frame rate of 60 P. In FIG. 7, a horizontal axis shows time. FIG. 7(a) shows an aspect in which video signals Vs1 to Vs6 imaged at the frame rate of 40 P are sequentially read from an image sensor at time intervals of 1/40 sec. FIG. 7(b) shows video signals that are recorded in a recording unit in the imaging device and FIG. 7(c) shows time codes that are added to the video signals Vs1 to Vs6 recorded in the recording unit in the imaging device.

As shown in FIG. 7(c), a time code “10:10:10:57” is added to the video signal Vs1 and a time code “10:10:10:58” is added to the video signal Vs2. That is, the time code steps once for each frame in synchronization with the video signal Vs. A carry frame number of the time code corresponds to a reproduction frame rate of 60 P. Therefore, after a lowest digit of the time code changes by one from “00” to “59” for each frame, the lowest digit is carried in the time code added to the video signal Vs4 and returns to “00.”

FIG. 7(d) shows a video signal that is read from the recording unit in the imaging unit and is output to the external device and FIG. 7(e) shows time codes that are added to the video signals. In this example, because the transmission frame rate of the video signal with respect to the external device is set to 60 P, as shown in FIG. 7(d), the video signals Vs1 to Vs6 are transmitted at time intervals of 1/60 sec. At this time, in the video signals Vs1, Vs3, and Vs5, the video signal of the same frame is transmitted twice in repetition. In the video signals in which the frame rate changes from 40 P to 60 P, a frame that does not include image data (video) is not generated. Thereby, even when the external device receiving the video signal Vs does not correspond to the variable frame rate imaging, a problem can be prevented from being generated in the external device at the time of reproducing the video signal.

The time code is added to each video signal that is shown in FIG. 7(d) and is read at time intervals of 1/60 sec. As shown in FIG. 7(e), when the time code steps by one frame at a time interval of 1/60 sec. in synchronization with the transmission frame rate and the lowest digit advances to “59,” the lowest digit is carried and returns to “00.”

However, the video and the time code may not be synchronized in the video signal transmitted to the external device by the processing described above. For example, as shown in FIG. 7(c), a time code “10:10:11:01” is added to the video signal Vs5 that is shown in FIG. 7(b) and is recorded in the recording unit in the imaging device. Meanwhile, a different time code “10:10:11:03” is added to the video signal Vs5 that is shown in FIG. 7(e) and is output to the external recording device.

The present disclosure has been made in view of the above-described problems and it is an object of the present disclosure to synchronize video and a time code in an externally output video signal when imaging is performed at an imaging frame rate different from a transmission frame rate of a video signal with respect to an external device.

According to an embodiment of the present disclosure, there is provided an imaging device which includes an imaging unit that performs photoelectric conversion with respect to object light and generates a video signal, a timing generating unit that instructs the imaging unit to generate the video signal at a predetermined imaging frame rate, a time code generating unit that generates a time code to be added to the video signal, and an output signal control unit that stores the video signal and the time code added to the video signal in a memory, reads a combination of the video signal and the time code stored in the memory at a second frame rate according to a transmission frame rate for when the video signal is transmitted to an external device, and outputs the combination.

According to another embodiment of the present disclosure, there is provided an imaging method which includes instructing to generate a video signal at a predetermined imaging frame rate, performing photoelectric conversion with respect to object light and generating the video signal at the imaging frame rate, generating a time code to be added to the video signal, storing the video signal and the time code added to the video signal in a memory, and reading a combination of the video signal and the time code stored in the memory at a second frame rate according to a transmission frame rate for when the video signal is transmitted to an external device, and outputting the combination.

By the configuration and the processing described above, the time code that is added when the imaging is performed is added to the video signal transmitted to the external device.

In the imaging device and imaging method according to the embodiments of the present disclosure described above, the time code that is added when the imaging is performed is added to the video signal transmitted to the external device. Therefore, video and a time code in an externally ^{output} video signal are synchronized with each other.

### BRIEF DESCRIPTION OF THE DRAWINGS

FIG. 1 is a block diagram showing a configuration example of a video system according to an embodiment of the present disclosure;

FIG. 2 is a block diagram showing a configuration example of a video camera recorder according to an embodiment of the present disclosure;

FIG. 3 is a diagram showing a relation between a video signal and a time code when a fast reproduction mode is set in an embodiment of the present disclosure, (a) showing an imaged video signal, (b) showing a video signal recorded in a recording unit in a video camera recorder, (c) showing a time code added to the video signal recorded in the recording unit in the video camera recorder, (d) showing a video signal transmitted to an external recording device, (e) showing a time code added to the video signal transmitted to the external recording device, and (f) showing a valid frame flag overlapping the video signal transmitted to the external recording device;

FIG. 4 is a diagram showing a relation between a video signal and a time code when a slow reproduction mode is set in an embodiment of the present disclosure, (a) showing an imaged video signal, (b) showing a video signal recorded in a recording unit in a video camera recorder, (c) showing a time code added to the video signal recorded in the recording unit in the video camera recorder, (d) showing a video signal transmitted to an external recording device, (e) showing a time code added to the video signal transmitted to the external recording device, and (f) showing a valid frame flag overlapping the video signal transmitted to the external recording device;

FIG. 5 is a flowchart showing an example of processing by a time code generator in an embodiment of the present disclosure;

FIG. 6 is a diagram showing a relation between a video signal and a time code during a recording start non-instruction period when a REC run mode is set in an embodiment of the present disclosure, (a) showing an imaged video signal, (b) showing a video signal recorded in a recording unit in a video camera recorder, (c) showing a time code added to the video signal recorded in the recording unit in the video camera recorder, (d) showing a video signal transmitted to an external recording device, (e) showing a time code added to the video signal transmitted to the external recording device, and (f) showing a valid frame flag overlapping the video signal transmitted to the external recording device; and

FIG. 7 is a diagram showing a relation between a video signal and a time code when a fast reproduction mode is set in the related art, (a) showing an imaged video signal, (b) showing a video signal recorded in a recording unit in a video camera recorder, (c) showing a time code added to the video signal recorded in the recording unit in the video camera recorder, (d) showing a video signal transmitted to an external recording device, (e) showing a time code added to the video signal transmitted to the external recording device, and (f) showing a valid frame flag overlapping the video signal transmitted to the external recording device

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Specific examples of a configuration and processing of an imaging device according to an embodiment of the present disclosure will be described in the order described below, with reference to the drawings.

1. Configuration Example of Video System according to Embodiment of Present Disclosure

2. Internal Configuration Example of Video Camera Recorder according to Embodiment of Present Disclosure

3. Example of Output Signal Control Processing according to Embodiment of Present Disclosure

4. Various Modifications

### <1. Configuration Example of Video System According to Embodiment of Present Disclosure>

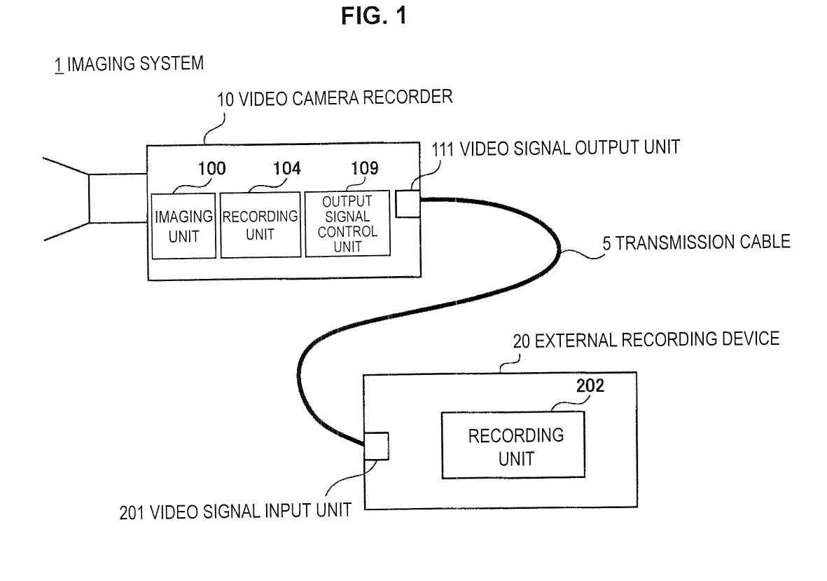

FIG. 1 is a diagram showing a configuration example of a video system to which an imaging device of the present disclosure is applied. A video system 1 shown in FIG. 1 includes a video camera recorder 10 that images broadcasting or movie contents and records the contents and an external recording device 20 that is connected to the video camera recorder 10 by a transmission cable 5. The imaging device of the present disclosure is applied to the video camera recorder 10. The video camera recorder 10 has a function of “variable frame rate imaging” for setting a frame rate when imaging is performed to any frame rate different from a reproduction frame rate and performing the imaging. Hereinafter, a mode in which the “variable frame rate imaging” is performed is called a “variable frame rate imaging mode.”

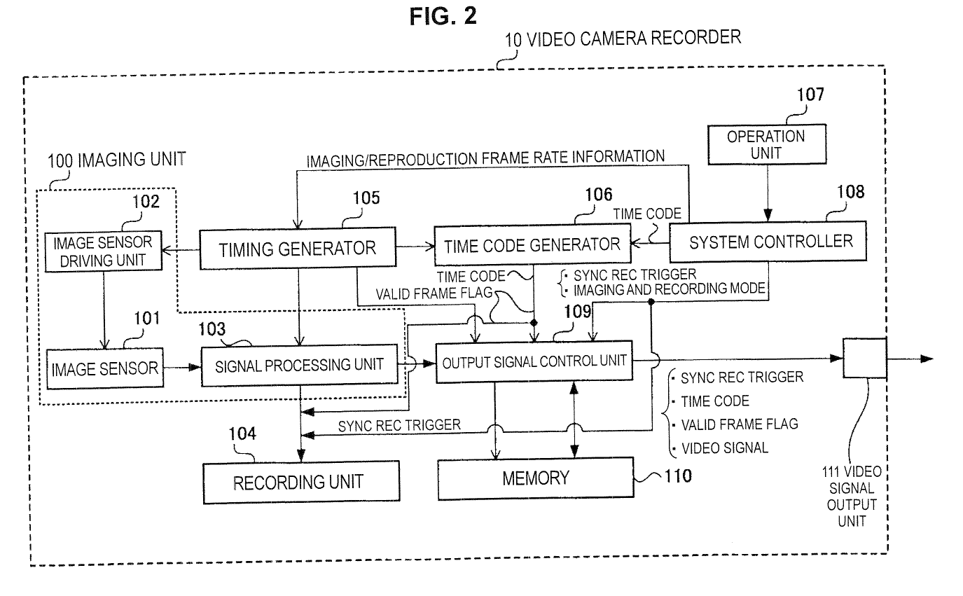

The video camera recorder 10 includes an imaging unit 100, a recording unit 104, an output signal control unit 109, and a video signal output unit 111. FIG. 1 schematically shows a function of each device forming the video system. The detailed configuration of the video camera recorder 10 will be described below with reference to FIG. 2.

The imaging unit 100 is configured using an image sensor and an image sensor driving unit that are not shown in the drawings and performs photoelectric conversion with respect to object light and generates a video signal. The recording unit 104 is configured using a video tape, a hard disk drive (HDD), or a memory card and records the video signal generated by the imaging unit 100. An output signal control unit 109 converts an imaging frame rate of the video signal acquired by the imaging unit 100 into a transmission frame rate (second frame rate) and outputs the video signal. The video signal in which the frame rate is converted by the output signal control unit 109 is transmitted to the external recording device 20 through the transmission cable 109. The video signal is transmitted to the external recording device 20 according to a standard such as a high definition serial digital interface (HD-SDI) standard.

The external recording device 20 is a device that records the video signal transmitted from the video camera recorder 10 and includes a video signal input unit 201 and a recording unit 202. The video signal input unit 201 is connected to the transmission cable 5 and the video signal output from the video camera recorder 10 is input to the video signal input unit 201. The recording unit 202 is configured using a video tape, an HDD, or a memory card and records the video signal input from the video signal input unit 201 as a video clip.

In this embodiment, the external device is applied to the external recording device. However, the present disclosure is not limited thereto. If the video signal transmitted from the imaging device is input to an external device, the external device may be applied to other devices such as a non-linear editing machine and a live switcher.

### <2. Internal Configuration Example of Video Camera Recorder According to Embodiment of Present Disclosure>

Next, the configuration example of the video camera recorder according to the embodiment of the present disclosure will be described with reference to a block diagram of FIG. 2. The video camera recorder 10 shown in FIG. 2 includes an imaging unit 100, a recording unit 104, a timing generator 105 functioning as a timing control unit, a time code generator 106 functioning as a time code generating unit, an operation unit 107, and a system controller 108. The video camera recorder 10 further includes an output signal control unit 109, a memory 110, and a video signal output unit 111.

The imaging unit 100 includes an image sensor 101, an image sensor driving unit 102, and a signal processing unit 103. The image sensor 101 performs photoelectric conversion with respect to object light imaged on a light receiving surface not shown in the drawings by a lens not shown in the drawings, reads obtained signal charge, and converts the signal charge into an electrical signal. The image sensor 101 is configured using a charge coupled device (CCD) sensor or a complementary metal oxide semiconductor (CMOS) sensor.

The image sensor driving unit 102 drives the image sensor 101 on the basis of a synchronization signal supplied from the timing generator 105 to be described below. The signal processing unit 103 executes a gamma correction operation or RGB/YC conversion processing with respect to the video signal obtained by the image sensor 101. The recording unit 104 accumulates the video signal on which the signal processing is executed by the signal processing unit 103.

The timing generator 105 generates the synchronization signal to the image sensor driving unit 102 and the signal processing unit 103, as well as to the time code generator 106 and the output signal control unit 109 to be described below, from a basic clock.

The time code generator 106 generates a time code in synchronization with the synchronization signal supplied from the timing generator 105, steps the time code, and supplies the time code to the recording unit 104 and the output signal control unit 109 to be described below.

As examples of a mode in which the time code is stepped, two kinds of modes “free run” and “REC run” are known. The time code generator 106 steps the time code according to any mode. The “free run” is a mode in which a time code is stepped in synchronization with real time. The “REC run” is a mode in which a time code is stepped only when recording (REC) is performed.

A stepping mode of the time code (hereinafter called “TC mode”) is input by a user through the operation unit 107 to be described below and is supplied as the TC mode from the system controller 108 receiving an input value to the time code generator 106. The time code generator 106 steps the time code according to the “free run” mode or the “REC run” mode on the basis of the input TC mode.

When imaging according to the “variable frame rate imaging mode” is instructed through the operation unit 107 to be described below, the time code generator 106 steps the time code in synchronization with a frame rate set as a reproduction frame rate. For example, when the reproduction frame rate is set to 24 P, the time code generator 106 steps a lowest digit of the time code from “00” to “23” by one for each frame, carries the lowest digit, and steps the lowest digit again from “00.”

The video camera recorder 10 according to this embodiment has a “synchronous recording mode” and a “normal mode” as an imaging and recording mode and changes a method of stepping a time code by the time code generator 106, according to the selected mode. The “synchronous recording mode” is a mode in which imaging and recording are performed such that video and a time code in an externally output video signal are synchronized. The “normal mode” is a mode in which imaging and recording are performed without synchronizing video and a time code in an externally output video signal.

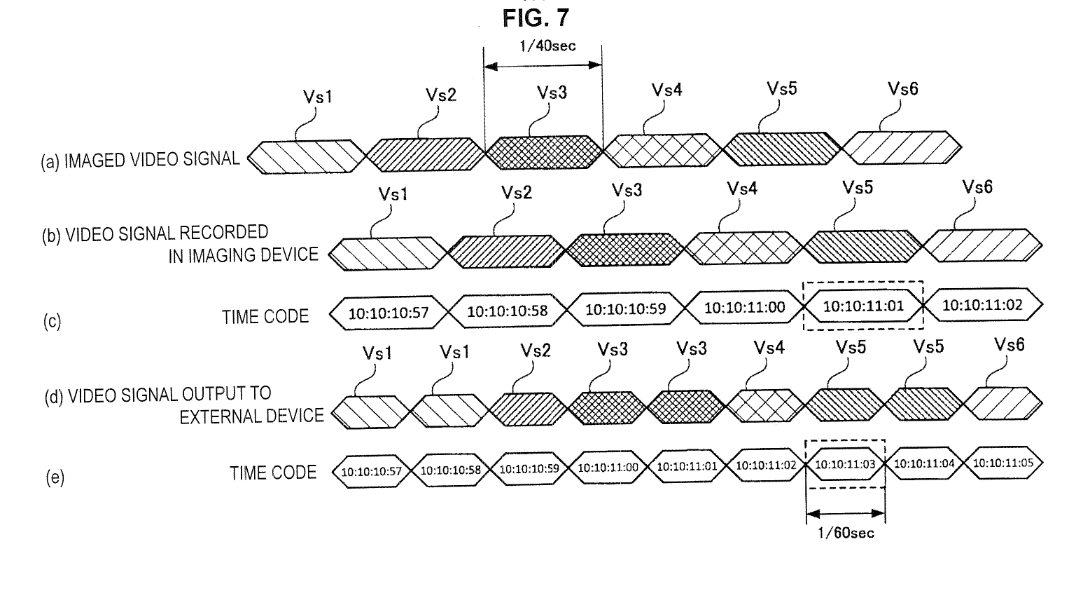

When the “normal mode” is set, as shown in FIG. 7 as an example of processing in the related art, a time code (refer to FIG. 7(e)) that is added to a video signal (refer to FIG. 7(d)) output to an external device steps for each frame in synchronization with a transmission frame rate. Meanwhile, a time code that is added to a video signal recorded in the recording unit 104 in the video camera recorder 10 steps for each frame in synchronization with a reproduction frame rate, as described above (refer to FIG. 7(c)).

That is, in the “normal mode,” the time code that is added to the video signal recorded in the recording unit 104 in the video camera recorder 10 and the time code that is added to the video signal output to the external recording device 20 are individually generated. Meanwhile, when the “synchronous recording mode” is set, only the time code that is synchronized with the reproduction frame rate is generated.

The operation unit 107 is configured using a REC button to instruct to start or stop recording, another button, a knob, or a switch. The operation unit 107 converts operation content input by the user into an operation signal and supplies the operation signal to the system controller 108. The system controller 108 is configured using a central processing unit (CPU) and controls each unit forming the video camera recorder 10.

The output signal control unit 109 converts an imaging frame rate of the video signal output from the signal processing unit 103 into a transmission frame rate and outputs the video signal. The conversion of the frame rate is performed by writing the input video signal to the memory 110 and reading the video signal from the memory 110 at timing based on the transmission frame rate. As the transmission frame rate, a frame rate faster than the imaging frame rate is generally set. For this reason, when the frame rate of the video signal is converted into a frame rate synchronized with the transmission frame rate, the same video is transmitted repetitively in some video signals, such that a frame not including video is not generated. That is, among the video signals written to the memory 110, the same video signal is read repetitively and the video signal is output to the video signal output unit 111.

At this time, the output signal control unit 109 writes the video signal and the time code added to the video signal to the memory 110. In the case in which the “synchronous recording mode” is set, the time code added to the video signal is used as it is, even when the same video signal is read repetitively from the memory 110 multiple times. That is, processing for adding another time code synchronized with the transmission frame rate to the externally output video signal is not executed. Thereby, in the externally output video signal, the video and the time code are synchronized with each other.

The output signal control unit 109 adds a “valid frame flag” showing that video is valid only for one video signal with respect to the video signals read repetitively multiple times. Only the video signal to which the “valid frame flag” is added is reproduced and an effect of slow reproduction or fast reproduction is obtained in the reproduced image. Therefore, in the recording unit 202 (refer to FIG. 1) in the external recording device 20, only the video signal to which the “valid frame flag” is added is recorded.

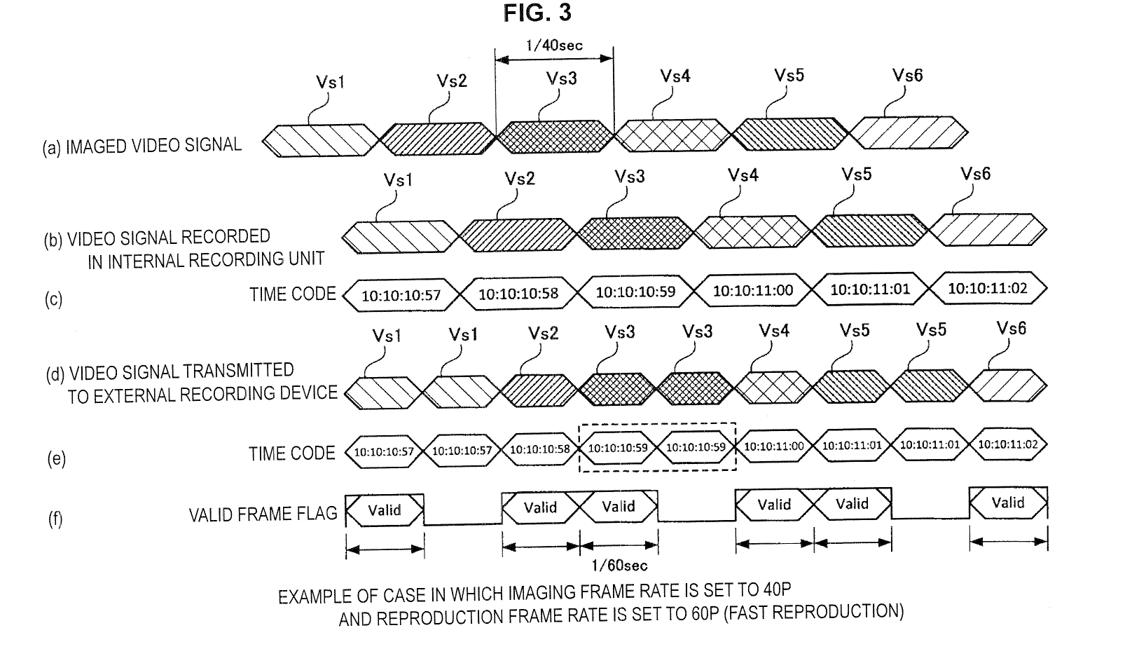

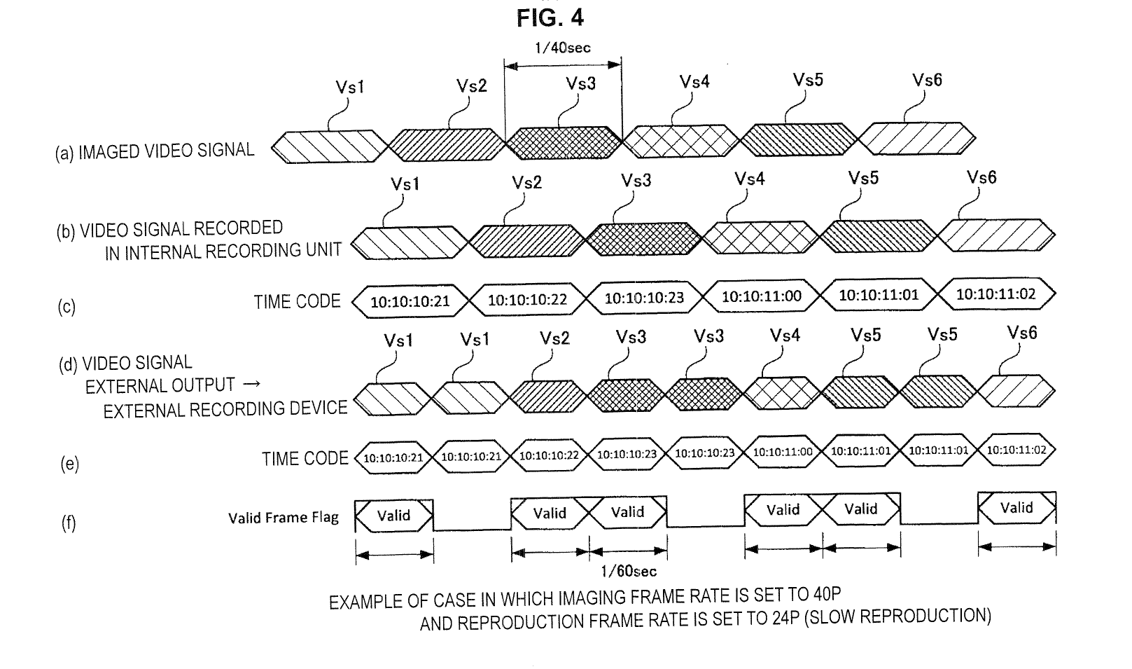

FIGS. 3 and 4 are diagrams showing correspondence of a video signal and a time code when a frame rate of an externally output video signal is converted into the same frame rate as a transmission frame rate, at the time of setting the “synchronous recording mode.” FIG. 3 shows processing when an imaging frame rate is set to 40 P and a reproduction frame rate is set to 60 P to obtain an effect of “fast reproduction” and FIG. 4 shows processing when an imaging frame rate is set to 40 P and a reproduction frame rate is set to 24 P to obtain an effect of “slow reproduction.” In FIGS. 3 and 4, portions that correspond to FIG. 7 shown as the example of the processing in the related art are denoted with the same reference numerals and repeated explanation of the portions is omitted.

First, the description will be made with reference to FIG. 3. As shown in FIG. 3(c), time codes that are synchronized with 60 P set as the reproduction frame rate are added to video signals Vs1 to Vs6 recorded in the recording unit 104 in the video camera recorder 10 shown in FIG. 3(b). A lowest digit of a time code showing a “frame” becomes “59” in the time code added to the video signal Vs3. Meanwhile, carried “00” is added to the next video signal Vs4. The video signal shown in FIG. 3(b) and the time code shown in FIG. 3(c) are recorded in the recording unit 104 (refer to FIG. 2) and are accumulated in the memory 110 for the frame conversion.

The output signal control unit 109 reads the video signal and the time code added to the video signal written to the memory 110 at time intervals of 1/60 sec. in synchronization with 60 P to be the transmission frame rate. At this time, in some video signals Vs, the same video is repetitively read multiple times to synchronize the frame rate of the video signal imaged at 40 P with a transmission frame rate of 60 P. In FIG. 3(d), in the video signals Vs1, Vs3, and Vs5, the same video is read twice in repetition. Because the time code written to the memory 110 with the video signal is read as it is, as shown in FIG. 3(e), the same time code is added to the same video. For example, the video signal Vs1 is read twice. However, the same time code “10:10:10:57” is added to all of the videos.

Because the same video is read twice in repetition in the video signals Vs1, Vs3, and Vs5 shown in FIG. 3(d), a value of the “valid frame flag” is set to “Valid” only for one video signal with respect to the video signals, as shown in FIG. 3(f). By this processing, the time code steps at update timing of a valid image in which the “valid frame flag” becomes “Valid.”

As the external recording device 20 (refer to FIG. 1), an external recording device that has a function of recording only a video signal to which a “valid frame flag” is added is used. Therefore, in the recording unit 202 in the external recording device 20, only the video signal to which the “valid frame flag” is added is recorded. Alternatively, the external recording device according to the related art may be configured to have the function described above. Because only the video signal to which the “valid frame flag” is added is reproduced by the external recording device 20, an effect of “fast reproduction” is obtained in the reproduction image. In the “fast reproduced” video signal, the video and the time code are synchronized with each other and continuity of the time code is maintained.

The processing shown in FIG. 4 to obtain an effect of “slow reproduction” is basically the same as the processing shown in FIG. 3. The processing shown in FIG. 4 is different from the processing shown in FIG. 3 in a carry frame number of the time code added to the video signal. In the processing shown in FIG. 4, because the reproduction frame rate is set to 24 P, the lowest digit of the time code is carried when counting is performed up to “23” and returns to “00.” Even when the imaging and recording are performed with the imaging frame rate set to be higher than the reproduction frame rate, video and a time code in an externally transmitted video signal are synchronized with each other and continuity of the time code is maintained.

Returning to FIG. 2, the description will continue. The output signal control unit 109 superimposes a “valid frame flag,” “SYNC REC TRIGGER” showing starting or ending of recording, and a time code on the video signal written to the memory 110. The external recording device 20 (refer to FIG. 1) that receives the video signal overlapping each signal starts or ends the recording in synchronization with the starting or ending of the recording shown by the “SYNC REC TRIGGER” and performs the recording at the same time or recording time as the video camera recorder 10. The “valid frame flag” and the “SYNC REC TRIGGER” may not overlap the video signal in a step of being written to the memory 110 and may overlap the video signal read from the memory 110.

The video signal output unit 111 outputs the video signal which is output from the output signal control unit 109 and which each signal is overlapped to the outside.

### <3. Example of Output Signal Control Processing According to Embodiment of Present Disclosure>

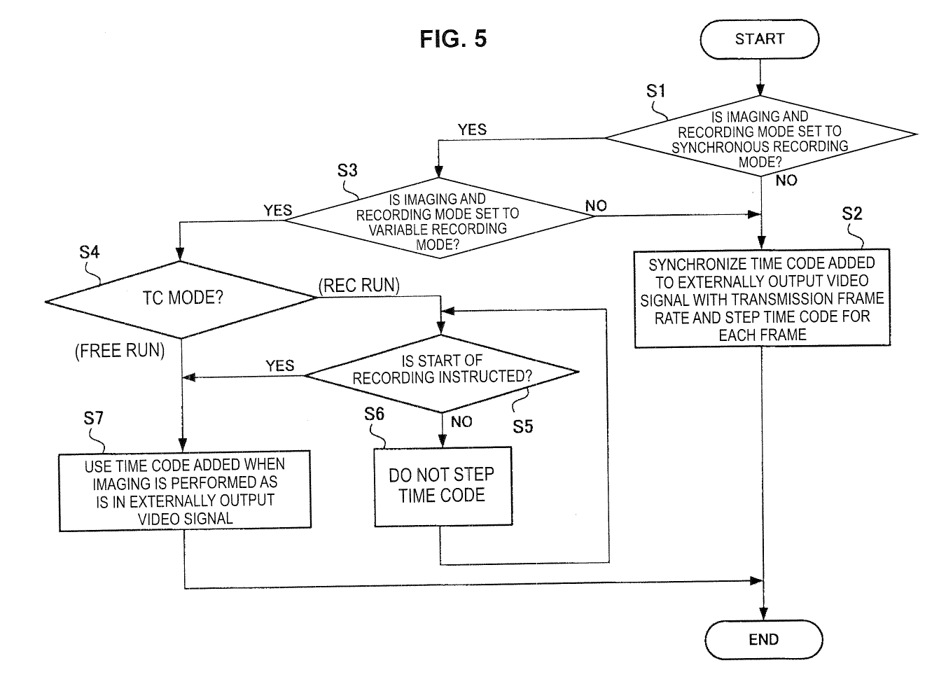

Next, an example of output signal control processing according to the embodiment of the present disclosure will be described with reference to FIG. 5. FIG. 5 is a flowchart showing time code stepping processing in the time code generator 106. First, the time code generator 106 determines whether an imaging and recording mode is set to a “synchronous recording mode” (step S1).

When the imaging and recording mode is not set to the “synchronous recording mode,” that is, the imaging and recording mode is set to the “normal mode,” the time code that is added to the externally output video signal is synchronized with the transmission frame rate and is stepped by one frame (step S2). By executing the processing, as shown in FIG. 7 as the example of the processing according to the related art, the time code (refer to FIG. 7(e)) that is added to the video signal output to the external device is not synchronized with the time code (refer to FIG. 7(c)) added to the video signal recorded in the recording unit 104 in the video camera recorder 10.

In step S1, when it is determined that the imaging and recording mode is set to the “synchronous recording mode,” it is determined whether the imaging and recording mode is set to the “variable frame rate imaging mode” (step S3). When the imaging and recording mode is not set to the “variable frame rate imaging mode,” the same processing as the processing according to the related art in step S2 is executed. When the imaging and recording mode is set to the “variable frame rate imaging mode,” a setting object of the “TC mode” is determined (step S4).

When the “TC mode” is set to “REC run,” it is determined whether start of the recording is instructed by the user through the operation unit 107 (refer to FIG. 2) (step S5) and the time code does not step when the start of the recording is not instructed (step S6).

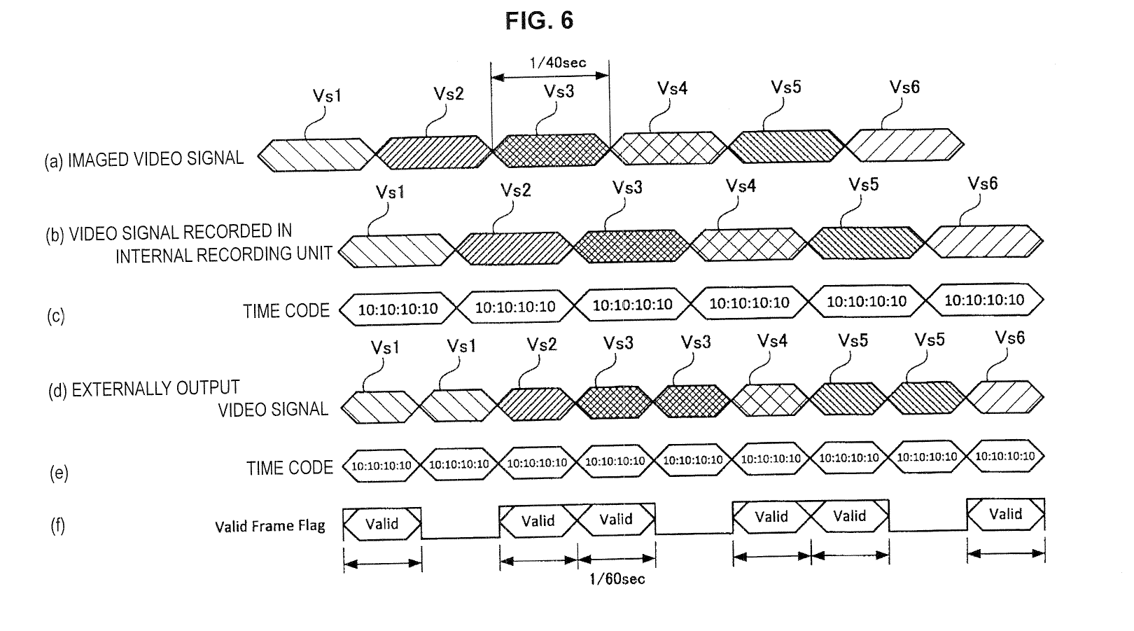

FIG. 6 is a diagram showing processing of step S7. In FIG. 6, portions that correspond to FIGS. 3, 4, and 7 are denoted with the same reference numerals and repeated explanation of the portions is omitted. The time codes “10:10:10:10” are added to the video signal that is shown in FIG. 6(b) and are recorded in the recording unit 104 in the video camera recorder 10 and the externally output video signal that is shown in FIG. 6(d) (refer to FIGS. 6(c) and (e)). That is, even though the “synchronous recording mode” and the “variable frame rate imaging mode” are set, the time code does not step when the “REC run” is set and the start of the recording is not instructed.

Returning to the flowchart of FIG. 5, the description will continue. In step S5, when it is determined that the start of the recording is instructed, the time code that is added at the time of imaging is used as it is in the externally output video signal (step S7). In step S4, even when it is determined that the “TC mode” is set to “free run,” the processing described above is executed. Because the processing of step S7 was described with reference to FIGS, 4 and 5, the repeated explanation thereof is omitted.

According to this embodiment described above, the same time code is added to the video signal in which the same video is read repetitively when the frame rate is converted. Thereby, the video signal on which the variable frame rate imaging is executed and the time code can be synchronized with each other and can be transmitted to the external device. For example, even when imaging is performed using a plurality of imaging devices, such as when a 3D image is imaged, the time codes that are added to the video signal recorded inside and the video signal output to the outside can be matched with each other.

The “valid frame flag” becomes “Valid” only for one video signal with respect to the video signals in which the same video is read repetitively. Thereby, in the video signal that is transmitted to the external device, the time code steps whenever the valid image is updated. Therefore, in the external device, the input video signal and time code are recorded without resetting (regenerating) the time code and a recording image in which continuity of the time code is secured can be obtained.

Only the valid image in which the “valid frame flag” is “Valid” is recorded in the external device and a combination of the same video signal and time code as the video signal and the time code recorded in the imaging device can be recorded in the external device.

According to the embodiment described above, the time code synchronized with the video, the “valid frame flag,” and the “SYNC REC TRIGGER” overlap the externally output video signal and the video signal is transmitted. Thereby, in both the imaging device such as the video camera recorder 10 and the external device such as the external recording device, video clips that have the same time, the same length, and the same time code can be recorded.

According to the embodiment described above, the recording image that is recorded in the imaging device and has the low bit rate can be used for proxy editing and the recording image that is recorded in the external device and has the high bit rate can be used for main recording. That is, time and effort necessary to newly generate an image for proxy editing can be decreased.

### <4. Various Modifications>

In the embodiment described above, the imaging device that is configured as the video camera recorder 10 performs the variable frame rate imaging. However, the present disclosure is not limited thereto. The present disclosure may be applied to “interval REC” for intermittently recording video, “frame imaging” for performing recording only when a REC button is pressed, and imaging by a slow shutter.

It should be understood by those skilled in the art that various modifications, combinations, sub-combinations and alterations may occur depending on design requirements and other factors insofar as they are within the scope of the appended claims or the equivalents thereof.

Additionally, the present disclosure may also be configured as below.

(1) An imaging device including:

an imaging unit that performs photoelectric conversion with respect to object light and generates a video signal;

a timing generating unit that instructs the imaging unit to generate the video signal at a predetermined imaging frame rate;

a time code generating unit that generates a time code to be added to the video signal; and

an output signal control unit that stores the video signal and the time code added to the video signal in a memory, reads a combination of the video signal and the time code stored in the memory at a second frame rate according to a transmission frame rate for when the video signal is transmitted to an external device, and outputs the combination.

(2) The imaging device according to (1),

wherein the imaging frame rate is set to a frame rate lower than the transmission frame rate.

(3) The imaging device according to (1) or (2),

wherein the output signal control unit superimposes a valid frame flag showing whether the video signal is a valid image on the video signal and the valid frame flag is valid only for one video signal with respect to video signals of a same frame read repetitively from the memory multiple times.

(4) The imaging device according to any of (1) to (3),

wherein the output signal control unit superimposes a synchronous recording trigger showing timing of starting or ending of recording designated by a user, on the video signal.

(5) The imaging device according to any of (1) to (4),

wherein the time code generating unit steps the time code in synchronization with a reproduction frame rate of a video signal set to a frame rate different from the imaging frame rate.

(6) An imaging method including:

instructing to generate a video signal at a predetermined imaging frame rate;

performing photoelectric conversion with respect to object light and generating the video signal at the imaging frame rate;

generating a time code to be added to the video signal;

storing the video signal and the time code added to the video signal in a memory; and

reading a combination of the video signal and the time code stored in the memory at a second frame rate according to a transmission frame rate for when the video signal is transmitted to an external device, and outputting the combination.

The present disclosure contains subject matter related to that disclosed in Japanese Priority Patent Application JP 2011-193829 filed in the Japan Patent Office on Sep. 06, 2011, the entire content of which is hereby incorporated by reference.

What is claimed is:

1. An imaging device comprising:
an imaging unit that performs photoelectric conversion with respect to object light and generates a video signal;
a timing generating unit that instructs the imaging unit to generate the video signal at a predetermined imaging frame rate;
a time code generating unit that generates a time code to be added to the video signal; and
an output signal control unit that stores the video signal and the time code added to the video signal in a memory, reads a combination of the video signal and the time code stored in the memory at a second frame rate according to a transmission frame rate for when the video signal is transmitted to an external device, and outputs the combination.

2. The imaging device according to claim 1,
wherein the imaging frame rate is set to a frame rate lower than the transmission frame rate.

3. The imaging device according to claim 2,
wherein the output signal control unit superimposes a valid frame flag showing whether the video signal is a valid image on the video signal and the valid frame flag is valid only for one video signal with respect to video signals of a same frame read repetitively from the memory multiple times.

4. The imaging device according to claim 3,
wherein the output signal control unit superimposes a synchronous recording trigger showing timing of starting or ending of recording designated by a user, on the video signal.

5. The imaging device according to claim 4,
wherein the time code generating unit steps the time code in synchronization with a reproduction frame rate of a video signal set to a frame rate different from the imaging frame rate.

6. An imaging method comprising:
instructing to generate a video signal at a predetermined imaging frame rate;
performing photoelectric conversion with respect to object light and generating the video signal at the imaging frame rate;
generating a time code to be added to the video signal;
storing the video signal and the time code added to the video signal in a memory; and
reading a combination of the video signal and the time code stored in the memory at a second frame rate according to a transmission frame rate for when the video signal is transmitted to an external device, and outputting the combination.
